(19) United States
(12) Patent Application Publication
(10) Pub. No.: US 2006/0102532 A1
(43) Pub. Date: May 18, 2006

(54) Water surface cleaning machine

(76) Inventor: Roland Cadotte JR., Freehold, NJ (US)

Correspondence Address: Roland Cadotte Jr., 219 Ticonderoga Blvd, Freehold, NJ, 07728, US

(21) Appl. No.: 11/280,769

(22) Filed: Nov. 16, 2005

Related U.S. Application Data
(60) Provisional application No. 60/628,393, filed on Nov. 16, 2004.

(51) Int. Cl. B01D 35/00

(52) U.S. Cl. 210/94

(57) ABSTRACT

The water surface cleaning machine is a self contained unit that travels on a water surface and collects floating debris. This water surface cleaning machine contains a propulsion means for propelling itself across the water. Debris is collected in a net or porous basket. The water surface cleaning machine contains a microcontroller to control its operations. The water surface cleaning machine has a manually operated mode and an automated mode. A radio controller can be used in the manual mode to remotely steer the water surface cleaning machine towards any floating debris for extremely quick and efficient cleaning of a water surface. In the automated mode, the water surface cleaning machine operates without intervention cleaning the pool of water and recharging its batteries. The water surface cleaning machine contains preprogrammed routines for efficiently cleaning the water surface. Switches or pressure sensors located on the exterior of its housing detect contact with external objects and a flow sensor monitors the water surface cleaning machine's motion. The microcontroller is programmed to redirect the water surface cleaning machine if its motion is prevented. The water surface cleaning machine is powered by batteries and solar cells. The microcontroller monitors the battery's charge, the solar cell's output and controls the recharging of the battery. The water surface cleaning machine includes an energy conservation mode to conserve the batteries energy. An analog to digital converter converts input from the batteries, flow sensors and switches to a form useable by the microcontroller.

### CROSS-REFERENCE TO RELATED APPLICATIONS

This application benefits from provisional application 60/628,393 filed Nov. 16, 2004. The title of the provisional application is Water Surface Cleaning Machine. The applicant is Roland Cadotte Jr.

### FIELD OF INVENTION

This invention relates to machines that travel on or near water surfaces that can be controlled remotely or that can operate automatically for cleaning the surface of a pool of water.

### DESCRIPTION OF THE PRIOR ART

Water surface cleaning machines are machines that travel on or near a surface of water collecting floating debris. Some machines travel in an undetermined mostly unpredictable manner. These machines travel unimpeded, until colliding with an external object or being confined by a vacuum hose or electrical cord. These machines can not be used for quick and selective cleaning of a certain region of a pool of water, since their direction of travel can not be controlled. Also because these machines can not be controlled, using them in a large pool or lake can be troublesome. They may end up stranded in the middle of a large pool or on the opposite side of a lake, making retrieval of these machines troublesome.

One water surface cleaning machine contains a radio control receiver for directing the machine. However this surface cleaning machine does not contain a means for collecting electromagnetic control signals which is necessary for proper operation. This surface cleaning machine doesn't contain a mechanical means for steering the machine and it doesn't contain a means for controlling the DC motors.

Some water surface cleaning machines operate autonomously. These water surface cleaning machines travel on the surface of a pool of water in a mostly non predictable pattern, changing directions only when colliding with another object. Some of these machines have arms to deflect themselves from collisions with walls and other obstacles. However these machines do not monitor their motion or their collisions with external obstacles. These machines do not clean the entire surface of a pool of water effectively. These machines can get caught on an obstacle and remain in one location for an extended period of time, thereby significantly limiting their cleaning effectiveness.

Some water surface cleaning machines are powered by an electrical cord connected to an external power source. Other water surface cleaning machines collect debris with a vacuum hose connected to an external filter. The movement of these water surface cleaning machines is limited by these external connections. In addition these machines can become tangled on these external connections, thereby severely limiting the water surface cleaning machine's effectiveness. These machines can not operate on a lake or pool of water that does not contain a power source or a filter.

Some water surface cleaning machines are powered by batteries, however they do not monitor the batteries charge. This is very important since without monitoring the batteries' charge, the user runs the risk of having the batteries becoming fully discharged during operation and stranding the machine in the middle of a pool of water. Some of the automated water surface cleaning machines use solar cells to recharge rechargeable batteries. These machines also do not monitor battery charge and consequently these machines are not capable of autonomously managing their energy supply. Therefore these water surface cleaning machines can run out of power at any time and at any location. Monitoring the batteries' charge is also critical to charging a rechargeable battery, since battery degradation or battery destruction can result from overcharging.

Some water surface cleaning machines are powered by only solar cells. These machines are not capable of operating in the dark, and therefore the ability of these machines to keep a pool of water clean is severely limited. Any debris that falls onto a surface of water during this time frame is likely to sink below the water surface, precluding the use of these water surface cleaning machines from ever collecting this debris.

Some water surface cleaning machines use DC motors to propel themselves across a pool of water. These machines however don't contain any means for controlling speed. Therefore the speed of the machine is set by the DC motor, its output gears, the battery voltage and the weight and drag of the water surface cleaning machine. This prevents the user from varying the speed during operation, limiting the effectiveness of the water surface cleaning machine in the manual mode. Without a means to vary the speed, a remote user can not increase the speed of the water surface cleaning machine to reach more quickly a distant location or to reduce the water surface cleaning machine's speed to make steering more accurate.

Some water surface cleaning machines contain a water permeable basket or net to skim debris from the water surface. These water surface cleaning machines collect floating debris, while traveling in the forward direction. These machines however do not have a means to prevent the collected debris from escaping from the water permeable basket or net, once forward travel is ceased. Therefore once forward travel is ceased, debris tends to float away the basket. This effect is magnified if the water surface cleaning machine travels in the reverse direction.

### SUMMARY OF THE INVENTION

The invention is a machine that is propelled across a surface of water and collects floating debris in a basket or netting. The water surface cleaning machine may contain a weir to prevent collected debris from exiting the basket. The water surface cleaning machine contains a manual mode of operation, so that the water surface cleaning machine can be controlled remotely with a transmitter that sends control signals to a receiver located in the water surface cleaning machine. The remote transmitter allows one to steer the water surface cleaning machine around the pool of water directly to floating debris such as leaves and insects permitting rapid cleaning of a pool of water. The water surface cleaning machine includes an automatic mode, whereby the water surface cleaning machine is propelled across the pool of water using programmed routines for efficient pool cleaning. The water surface cleaning machine includes switches located on the outside of the water surface cleaning machine that alert the water surface cleaning machine that it has hit a wall or other obstacle. The water surface cleaning machine changes direction of travel when coming in contact with an obstruction. The water surface cleaning machine contains two DC motors attached to paddle wheels that propel the water surface cleaning machine along the surface of water. The direction of travel can be controlled by applying more thrust to one paddle wheel relative to the second paddle wheel. In another embodiment, the cleaning machine contains one DC motor connected to a propeller for propelling the water surface cleaning machine and a DC servo motor connected to a rudder to steer the water surface cleaning machine. The DC motors in all embodiments are powered by batteries or other power sources located in the water surface cleaning machine. Rechargeable batteries are preferred for continuous operation. The water surface cleaning machine includes a solar cell for powering the water surface cleaning machine and recharging the rechargeable batteries. The water surface cleaning machine actively monitors the batteries' charge and the solar cell output, preventing the batteries from overcharging or from becoming fully discharged.

The water surface cleaning machine contains a microcontroller that controls the operation of the water surface cleaning machine including controlling the power applied to each DC motor. The microcontroller contains an analog to digital converter that converts analog data from the batteries, solar cell, flow sensors and switches. This data is used by the microcontroller to monitor the batteries' charge, the solar cell's output and the direction and speed of travel of the water surface cleaning machine. The microcontroller is powered by a separate battery from those powering the DC motors. This allows the microcontroller to be isolated from transients and other electromagnetic interference caused by the DC motors. In addition the separate battery allows the microcontroller to control the water surface cleaning machine even if the large rechargeable batteries become discharged. The separate battery allows the microcontroller to use the solar cell to recharge the DC motor's rechargeable batteries, bringing the water surface cleaning machine back to full functionality. The water surface cleaning machine also contains a control pad that includes an on off switch, a momentary switch to toggle the water surface cleaning machine into the desired operation mode and a liquid crystal display (LCD).

### BRIEF DESCRIPTION OF THE DRAWING

The various embodiments of the water surface cleaning machine are described in detail below, with reference to the drawings, in which like items are identified by the reference designations, wherein:

FIG. 1 is a pictorial view of one embodiment of the water surface cleaning machine containing manual and automatic modes.

FIG. 2 is a second pictorial view of said embodiment of the water surface cleaning machine containing manual and automatic modes.

FIG. 3 is a block diagram of an embodiment of the water surface cleaning machine containing a manual mode.

FIG. 4 is a block diagram of an embodiment of the water surface cleaning machine containing automatic and manual modes.

FIG. 5 is a circuit diagram of one embodiment of the water surface cleaning machine.

FIG. 6 is a flow chart showing the Main Software Routine for one embodiment of the water surface cleaning machine.

FIG. 7 is a flow chart showing the Automatic Mode Subroutine for one embodiment of the water surface cleaning machine.

FIG. 8 is a flow chart showing the Battery Test Portion of the Automatic Mode Subroutine for one embodiment of the water surface cleaning machine.

FIG. 9 is a flow chart showing the Manual Mode Subroutine for one embodiment of the water surface cleaning machine.

FIG. 10 is a flow chart showing the Battery Test Portion of the Manual Mode Subroutine for one embodiment of the water surface cleaning machine.

### DETAILED DESCRIPTION OF THE INVENTION

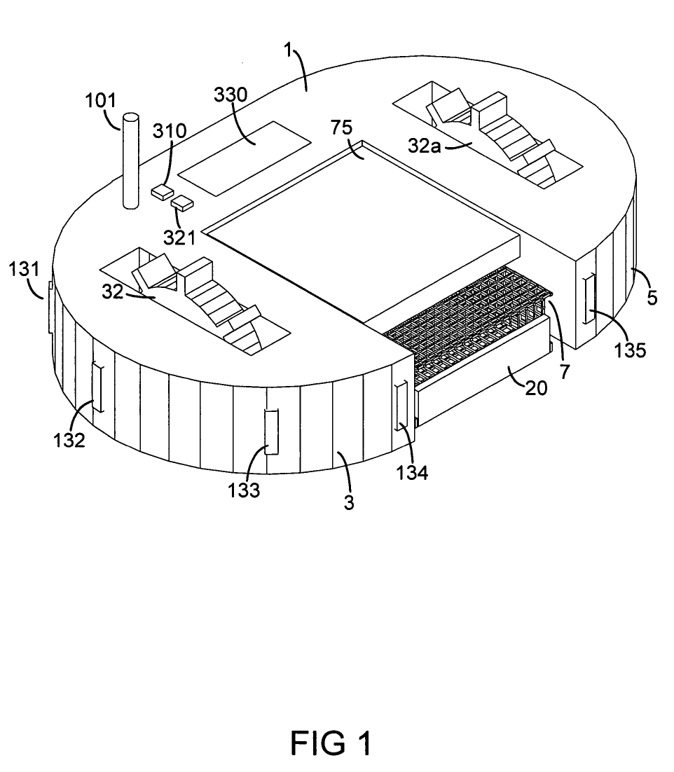

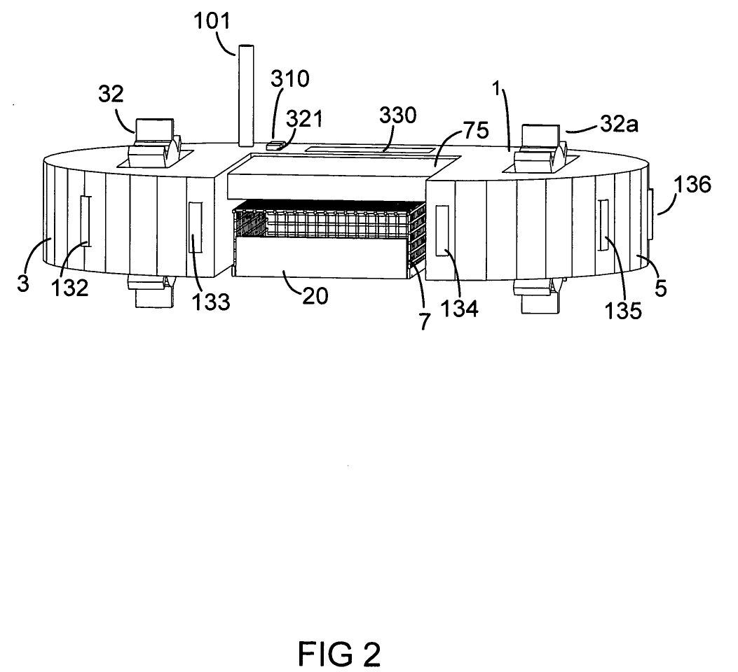

The water surface cleaning machine contains a housing 1 that is propelled across a surface of water. FIG. 1 and FIG. 2 show two different views of the water surface cleaning machine containing both the automatic and manual modes of operation. The housing 1 contains a porous basket 7 that collects floating debris, as the water surface cleaning machine travels. The basket collects debris and other floating objects, but does not hold water. The basket is secured in the water surface cleaning machine with its opening perpendicular to the water surface. The collection basket can take many forms including a disposable net.

The water surface cleaning machine contains a weir 20 to prevent debris from escaping from the basket 7. The weir 20 is located in front of the basket 7 and allows floating debris to be collected, but prevents debris from exiting the basket 7. The weir 20 is a rectangular volume that pivots around a line located below the water surface. The weir's 20 surfaces are made of plastic for its low cost and low weight; however other materials can be used. The weir stands in an upright position when the water surface cleaning machine is stationary, because the density of the weir 20 is less than that of water. As the water surface cleaning machine moves, the water forces the weir 20 below the water surface allowing debris to enter the basket 7. A stop located in front of the weir 20 prevents the weir from going below the water surface, when the water surface cleaning machine travels in the reverse direction.

The housing 1 can take numerous forms including common hull designs such as hydros and monohulls. FIG. 1 and FIG. 2 show the water surface cleaning machine with a hydro type of hull, which is defined as a housing that rides on two more surfaces. In this embodiment the porous basket 7 used for collecting debris is located between two hulls 3, 5. An alternative configuration is to use a monohull type body with a debris collecting basket located along each side of the monohull. This configuration facilitates cleaning the sides of a pool of water, since the baskets are on the outside of the water surface cleaning machine. Other types of hulls can also be used in the water surface cleaning machine. The housing 1 shown in FIG. 1 and FIG. 2 is curved to minimize the probability of being caught or stuck on obstacles. This is very important when the water surface cleaning machine operates autonomously. A curved housing permits the machine to be easily rotated into a non obstructed position. Housings that are not curved are useable, however the probability of being caught on an obstruction is increased. A non curved housing can include a curved guard secured to the outside of the housing to minimize the probability of being caught on an obstruction. Any guard situated in front of the collecting basket would ideally be located above the water surface so as not to interfere with debris collecting. The housing 1 can be fabricated from numerous materials including wood and fiberglass. In this embodiment, plastic is used for its low cost and strength.

The water surface cleaning machine contains a propulsion system that propels said water surface cleaning machine across a surface of water. In the embodiment shown in FIG. 1 and FIG. 2, two paddle wheels 32, 32a located in hulls 3, 5 respectively propel the water surface cleaning machine across the water. Other embodiments can use propellers instead of paddle wheels. Each has its own advantages and disadvantages. Paddle wheels don't require an axle from a DC motor that is submerged in the water, as is typically true with propellers. Since only the bottoms of the paddle wheels are submerged, the axels from DC motors to the paddle wheels can be located above the surface of water. This allows a housing 1 to be constructed that is less likely to leak over time, since the openings in the housing 1 through which the axels protrude are above the water surface. Whether these openings are above or below the water surface, common techniques exist to minimize water leakage into the housing 1 including extending the axel through a chamber filled with non water soluble grease. This grease allows the axel to turn freely, but prevents or minimizes the amount of water that can seep into housing 1. Other techniques can also be used to minimize water leakage.

The water surface cleaning machine in this embodiment is capable of traveling in various directions and at various speeds, by controlling the thrust of the individual paddle wheels 32, 32a located ideally on opposite sides of the water surface cleaning machine. More thrust by one paddle wheel 32 relative to the other paddle wheel 32a will cause the water surface cleaning machine to turn, assuming no other forces are acting upon the water surface cleaning machine. Greater thrust in general will propel the water surface cleaning machine at greater speeds. If the water surface cleaning machine is blocked and its forward motion is prevented, the paddle wheels 32, 32a can be made to rotate in opposite directions with respect to each other, causing the water surface cleaning machine to rotate into potentially an unobstructed position. Alternatively, if both paddle wheels 32, 32a are made to rotate in the reverse direction, the water surface cleaning machine will travel backwards unless it is hindered by an obstruction.

In an alternative embodiment, the propulsion system from the previous embodiment is modified. In this alternative embodiment, one DC motor powers a paddle wheel or a propeller that propels the water surface cleaning machine. This paddle wheel or propeller is located along a line extending from the front of the water surface cleaning machine to the back of the water surface cleaning machine. This line is located along the water surface cleaning machine's center of gravity and minimizes the probability that the machine drifts to the right or left as it travels. A rudder is located in the water surface cleaning machine and controls the water surface cleaning machine's direction of travel. A modified DC motor, called a servo controls the rudder. The servo converts electrical signals from a controller or receiver into mechanical motion that controls the rudder. The servo is connected to the rudder with push rods or other types of mechanical devices called linkages. The electronic circuitry for this embodiment is very similar to the circuitry in the previous embodiment except the DC motor is replaced by a DC servo motor that controls the rudder.

Consideration in all embodiments must be given to the weight and weight distribution of the water surface cleaning machine. It is important that the water surface cleaning machine travels in the desired direction and not pulled to one side because of an unequal weight distribution. Weights can be placed inside the water surface cleaning machine to evenly distribute weight across the machine. In addition the weight and drag of collected debris should not overly interfere with the motion of the water surface cleaning machine.

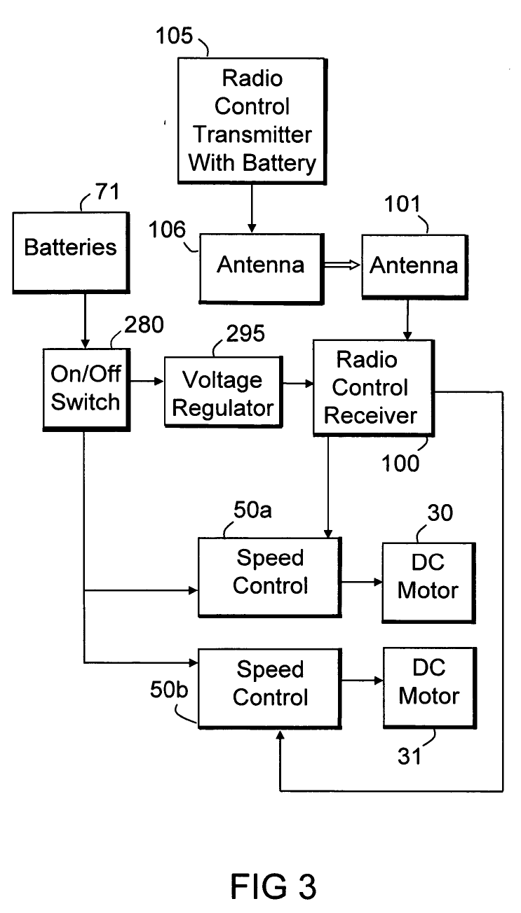

A block diagram of the main electrical sections of a water surface cleaning machine containing only a manual mode is shown in FIG. 3. The water surface cleaning machine contains five series 1.2 Volt D size batteries 71 to power the water surface cleaning machine. These series batteries supply 6 Volts when fully charged. The water surface cleaning machine contains an ON OFF switch 280 that turns on and off the water surface cleaning machine by closing or opening the connection between the batteries 71 and the rest of the circuitry. The TK11445 voltage regulator 295 manufactured by Toko in Mt. Prospect, Ill. regulates the battery voltage to a constant 4.5 Volts. The R113iP three channel receiver 100 manufactured by Futaba, Champaign, Ill. 100 needs a supply voltage of between 3 Volts and 10 Volts. The batteries 71 are capable of supplying this voltage directly; however it's beneficial to regulate a receiver's supply voltage. Therefore, the regulated voltage from the voltage regulator 295 is applied to the receiver 100. The receiver receives control data from a radio control transmitter 105 located remotely. The radio control link between the Futaba 3PK TI Black 75 three channel remote transmitter 105 and the receiver 100 allows the user to remotely steer the water surface cleaning machine towards floating debris for extremely quick and efficient water surface cleaning. Numerous other receivers and transmitters could be used in the water surface cleaning machine. The receiver 100 and transmitter 105 are connected to monopole or whip type of antennae 101, 106 respectively that transfers the electromagnetic signals between their respective electronic circuitry. Monopole or whip type antennae 101, 106 are ideal for this application because of their low cost. The BRUMS5110 radio control antenna by Bru-Line Industries, Center Line, Mich. is a whip type antenna that can be used as a receive or transmit antennae 101, 106, though the Futaba 3PK TI Black 75 three channel remote transmitter 105 is already equipped with an antenna. Other antenna types are suitable, including planar antennae. The range of radio control transmitters and receivers is sufficient for controlling the water surface cleaning machine in almost all swimming pools and in many lakes. In addition radio control systems are not severely limited by obstructions or by heat like other transmitter-receiver links including infrared. Radio control (RC) transmitters 105 and receivers 100 are ideal for use with the water surface cleaning machine, though other types of receivers and transmitters can be used.

Radio control transmitters 105 typically send steering and speed control information using pulse position modulation or pulse code modulation. These modulation types allow a number of signals to be interleaved, allowing control signals for both DC motors 30, 31 in the first embodiment or control signals for a DC motor and a DC servo in a second embodiment to be transmitted and received. Radio control systems use a carrier signal at one of a number of frequencies approved by the Federal Communications Commission. One of these frequencies is at approximately 75 MHz. Numerous radio control receiver and transmitter systems are available commercially that can be included in the water surface cleaning machine. In another embodiment, the water surface cleaning machine contains a transmitter that can send operating information from the water surface cleaning machine to a receiver located remotely.

The water surface cleaning machine contains speed control for controlling the speed of the DC motors 30, 31 and therefore the speed of the water surface cleaning machine. Techniques for controlling the DC motors 30, 31 are typically divided into two categories called mechanical speed control (MSC) and electronic speed control (ESC). Mechanical speed controls use a servo to vary a resistance in series with the DC motor. The servo's output shaft is connected to a contact that sweeps across a resistor as the servo's shaft moves. As the contact moves, the resistance in series with the DC motor changes. The power delivered to the DC motor decreases as the resistance increases thereby decreasing the DC motor's speed or torque. This is a very simple and mature technique. However, this technique is very inefficient, since a significant amount of power is dissipated in the resistor.

Electronic speed controllers efficiently control the speed of DC motors. This type of controller typically applies a pulse width modulated (PWM) signal to the motor. A pulse width modulated signal is a signal that contains a pulse that is repeated at a constant frequency. The period of this pulse is varied, while all other parameters are held constant. By controlling the period of this pulse, the amount of signal energy during a given period of the modulation is controlled. A PWM signal controls the speed of a motor by controlling the amount of energy applied to the motor. Increasing the amount of energy will increase a motor's speed or torque. The DC motor operates continuously and smoothly despite being powered by a modulated signal, since the motor appears as a large inductor that averages the signal's energy. The motor is controlled by the average energy content of the signal and not the envelope of the signal.

The R113iP 3 channel receiver 100 manufactured by Futaba, Champaign, Ill., as well as most radio control receivers were designed to interface with most radio control speed controllers, including the Astro-Flight 208D electronic speed controllers 50a, 50b. The receiver 100 has three different channels to control three speed controllers, though two are all that is required in this embodiment. The receiver 100 sends the control data that it receives from the transmitter 105, to the speed controllers 50a, 50b to control the DC motors 30, 31.

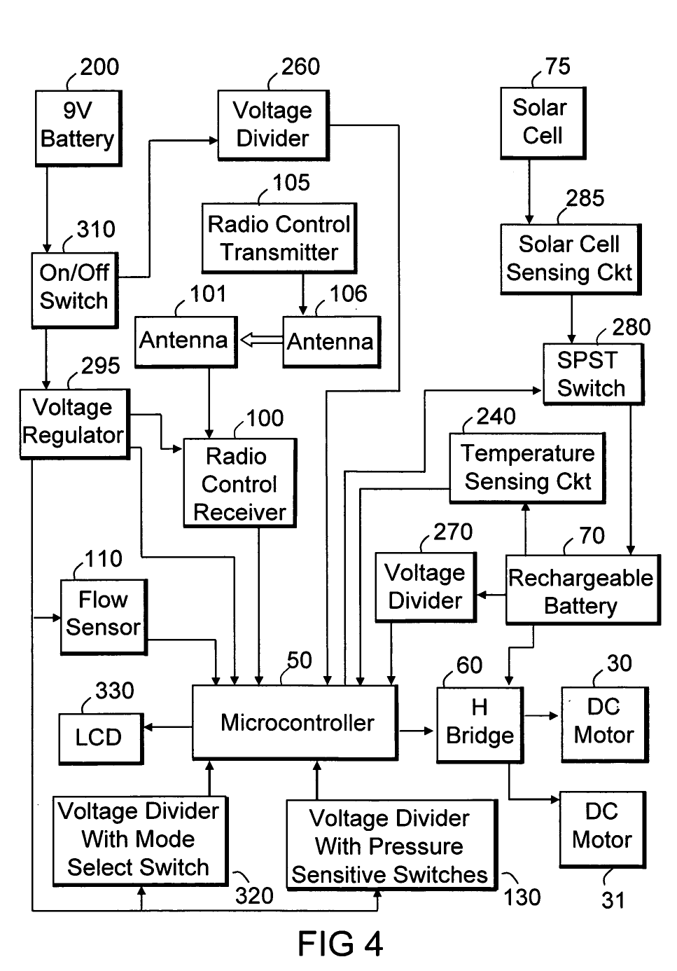

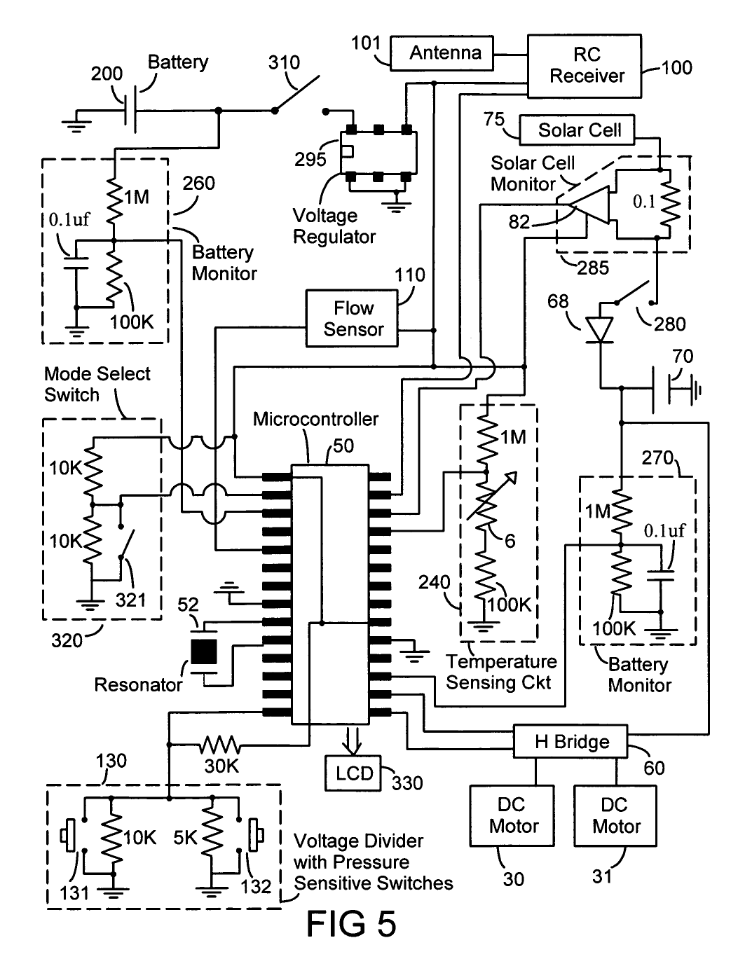

A block diagram of the main electrical sections of said water surface cleaning machine containing both manual and automated modes is shown in FIG. 4. A circuit schematic of some of the main components used in this embodiment of the water surface cleaning machine is shown in FIG. 5. In this embodiment, the water surface cleaning machine includes a microcontroller 50 for controlling the operation of the water surface cleaning machine, including acting as an electronic speed controller. In this embodiment, the water surface cleaning machine uses a PIC16C72 microcontroller 50 by Microchip Technology Inc., Chandler, Ariz. that can output a pulse width modulated signal. Other microcontrollers can be used depending on the exact configuration of the water surface cleaning machine. An appropriate frequency for a PWM signal is between 20 kHz and 30 kHz. This frequency is above human hearing and typically in a range where DC motors 30, 31 are without mechanical resonance problems. Microcontrollers 50 typically operate at rates above 1 MHz, therefore a PWM signal can be outputted at 20 kHz. The PIC16C72 microcontroller 50 contains an analog to digital converter (ADC) and embedded memory for storing data and programming. The PIC16C72 consumes only 2.7 ma of current. The microcontroller 50 requires a resonator 52 as shown in FIG. 5 to operate. The EFO-EC4004A4 4 MHz resonator 52 by Matshushita Electric Corporation of America (Panasonic), Secaucus, N.J. can be used in this embodiment, as well as resonators from numerous other manufacturers.

The PIC16C72 microcontroller 50 can output a PWM signal; however the energy from this signal is typically not large enough to energize a DC motor. The microcontroller's PWM signal is large enough however to control an H bridge 60, which is a controllable device that can supply large currents to a DC motor. An H bridge 60 is an electrical circuit containing four switches. The four switches are configured such that by applying the proper voltages to the four switch's control terminals, an H bridge 60 will cause a DC motor to turn clock wise, counter clockwise or to stop. A number of integrated circuit manufacturers fabricate H bridges 60 that are readily available in small inexpensive packages. Typically each package contains more than one H bridge 60 and many of these are designed to be interfaced with a microcontroller 50. The SN754410 by Texas Instruments is an integrated circuit containing two H Bridges 60 and can control two DC motors 30, 31. The SN754410 is being used in this embodiment of the water surface cleaning machine, though other H Bridges can be used.

The DC motors 30, 31 are powered by electricity with the preferred power source being rechargeable batteries. Solar panels 75 are included in the water surface cleaning machine with manual and automated modes to power the water surface cleaning machine as well as recharge the batteries. During the day, the solar panel 75 recharges the batteries 70 and powers the DC motors 30, 31 and at night the batteries 70 power the DC motors 30, 31. The batteries 70 in this manual and automatic embodiment of the water surface cleaning machine are of the rechargeable type. The batteries 71 in the manual only embodiment do not have to be rechargeable. Other sources of electrical power can also be used.

In the automatic mode, the microcontroller 50 controls the direction of travel of the machine. The microcontroller 50 is programmed with a number of routines for efficient pool cleaning. One type of routine is based on random travel around the pool. The microcontroller 50 is programmed with a sequence of random numbers. Each random number corresponds to travel in a certain direction for an increment of time. In this embodiment, random whole numbers from 0 to 8 are used. 0 and 1 represent travel in the forward direction for 10 and 20 seconds respectively. 2 and 3 represent travel in the reverse direction for 10 and 20 seconds respectively. 4 and 5 represent travel for 10 and 20 seconds respectively after rotating the water surface cleaning machine for 1 second in the clockwise direction and similarly for 6 and 7 but with the water surface cleaning machine rotated in the counter clockwise direction. Numerous other patterns can be used for efficient pool cleaning and to minimize the probability that the water surface cleaning machine remains in an area of a pool for excessive periods of time. Other routines include continuous travel until contact with an object is made. When this occurs the water surface cleaning machine rotates for a period of time and then continues in the forward direction until another object is contacted. This routine is repeated continuously until instructed to stop.

The microcontroller 50 monitors the motion of the water surface cleaning machine in the automated mode. The microcontroller 50 monitors the outputs from all the sensors and switches located in the water surface cleaning machine including pressure sensors 131, 132, 133, 134, 135, 136 shown in FIG. 1 and FIG. 2. The pressure sensors 131, 132 are included as elements in voltage divider 130 shown in FIG. 5 and are used to notify the microcontroller 50 that the surface cleaning machining has contacted an object. The output from voltage divider 130 is inputted into the microcontroller's 50 analog to digital converter. When a pressure sensor 131, 132 is pressed or touched, its resistance changes. This alters the output of the voltage divider 130. The microcontroller 50 monitors the output of the voltage divider 130 and adjusts the operation of the water surface cleaning machine to this input. For example a change in state of a pressure sensor 131 located on the exterior of the housing 1 will alert the water surface cleaning machine that it has come into contact with an obstacle and the direction of travel of the water surface cleaning machine should be changed. The microcontroller 50 is programmed to know the location of each individual switch, allowing the water surface cleaning machine to travel away from any obstruction that comes into contact with the water surface cleaning machine. A voltage divider for each switch or sensor is not required. More than one sensor or switch can be included in a single voltage divider 130, while still permitting the microcontroller 50 to determine the unique switch that came into contact with an obstruction. The microcontroller 50 is programmed with the expected output voltage from the voltage divider 130 when either switch 131, 132 is contacted. FIG. 1 shows pressure sensitive switches 131, 132, 133, 134, 135 located on the exterior of the water surface cleaning machine. FIG. 2 shows pressure sensitive switches 132, 133, 134, 135, 136 located on the exterior of the water surface cleaning machine. For brevity, FIG. 5 shows only two of these switches 131, 132. The TL1100C momentary switch, by E-Switch, Brooklyn Park, N.Y. can be used for the external pressure sensitive switches 131, 132. Numerous other switches and pressure sensors can also be used.

The water surface cleaning machine containing both manual and automated modes contains one 155421 RFO type flow sensor 110 by Gems Sensors, Plainville, Conn. to measure the forward motion of the water surface cleaning machine. The flow sensor 110 requires approximately 4V to operate and consumes approximately 8 ma, when there is zero water flow through the flow sensor 110. The flow sensor 110 outputs a modulated voltage signal whose frequency increases with water flow through the flow sensor 110. The flow sensor's modulated output voltage is inputted into the microcontroller's 50 analog to digital converter. The microcontroller 50 determines the relative speed of the water surface cleaning machine by determining the frequency of the flow sensor's 110 modulated outputted signal. If the sensor shows no forward motion with the propulsion system in the on state, the probability is high that an obstruction is preventing the water surface cleaning machine's motion. When this condition occurs, the microcontroller 50 sends the proper signals to the H bridge 60 to rotate the water surface cleaning machine or to have it travel backwards. The water surface cleaning machine may also contain two flow sensors for determining more accurately the motion of the water surface cleaning machine. These flow sensors would be positioned to measure the orthogonal vectors of motion. There are a number of forces that can alter the direction and speed of the water surface cleaning machine, including wind, water current, obstacles and drag from collected debris. If the microcontroller 50 determines that no motion is possible, the microcontroller 50 will put the water surface cleaning machine into the standby mode for a period of time to conserve the batteries' 70 energy. After a period of time, typically 10 minutes the microcontroller will again try to propel the water surface cleaning machine. RFO type flow sensors 110 manufactured by Gems Sensors are suitable for this application.

A mode select switch 321 is used to toggle the water surface cleaning machine between automatic and manual modes. The mode select switch 321 is included in voltage divider 320. The output of voltage divider 320 is inputted into the analog to digital converter located in the microcontroller 50 to instruct the microcontroller 50 to put the water surface cleaning machine into either the automatic or manual modes.

The water surface cleaning machine containing the automatic mode contains two separate battery supplies. One battery 200 supplies power to the microcontroller 50, the radio control receiver 100 and other low powered components within the water surface cleaning machine as shown in FIG. 4 and FIG. 5. Since the microcontroller 50 draws very little current, approximately 2 ma, the microcontroller 50 can be powered by a 9V battery 200 for approximately one month of operation. A typical alkaline 9 Volt battery has approximately 500 ma-hours of capacity. This battery 200 does not have the capacity for powering the DC motors 30, 31, since the DC motors 30, 31 can easily consume 100 to 200 ma of current and would therefore discharge a 9 Volt alkaline battery 200 in several hours. The voltage from a 9Volt battery 200 is typically too large for many microcontrollers and this voltage decreases significantly with decreasing stored battery charge. A voltage regulator 295 can be used to convert the output from the 9 Volt battery to a constant level appropriate for powering the microcontroller 50 and radio control receiver 100. The TK11445 voltage regulator 295 from Toko converts the unregulated voltage output from the 9 Volt battery 200 to a constant 4.5 Volt. The DC motors 30, 31 in this embodiment are supplied by larger rechargeable batteries 70. D cell rechargeable NiMh batteries have 9000 ma-hrs of capacity. This capacity is sufficient to power the DC motors 30, 31 continuously for one to two days depending on the speed and torque of the DC motors 30, 31. Various sized DC motors 30, 31 can be used depending on the size and weight of the water surface cleaning machine. Typically however DC motors will need its speed reduced and torque increased by using a series of gears attached to its axel. Several D cell batteries in series are required to power the motors, since D cell batteries supply only 1.2 Volts. This voltage level is less than the voltage required by the DC motors 30, 31 to operate efficiently. Five D cell batteries 70 in series will supply 6 Volts when fully charged, a sufficient voltage to power the DC motors. Despite having the energy capacity to supply the microcontroller 50, these larger rechargeable batteries 70 are not used to supply power to the microcontroller 50. Separate batteries 200 are used to minimize the possibility that the microcontroller is affected by electromagnetic interference from the DC motors 30, 31. In addition, the microcontroller 50 is powered by separate batteries 200 to allow the microcontroller 50 to control the water surface cleaning machine, independent of the state of charge of the large rechargeable batteries 70. Various sized batteries can be used depending on the size, weight, and numerous other factors influencing the water surface cleaning machine.

The microcontroller 50 manages the power consumption and battery charge in the water surface cleaning machine, when the water surface cleaning machine operates in the automatic mode. The microcontroller 50 has been programmed to monitor the rechargeable batteries' 70 charge, the solar cell's 75 output and the water surface cleaning machine's power consumption. The microcontroller 50 manages the water surface cleaning machine's power consumption based on the rechargeable battery's charge and the solar cell's 75 output. Under full charge, the water surface cleaning machine travels around the pool of water continuously at a nominal rate. If the charge on the rechargeable batteries 70 drop to approximately 50% of its full capacity the water surface cleaning machine goes into an energy conservation mode. In this mode, the water surface cleaning machine is made to travel more slowly to conserve the batteries' 70 charge. The on period of the pulse width modulation signal that controls the DC motors 30, 31 is decreased. This on period is decreased linearly with decreasing battery 70 charge. If the batteries' 70 charge drops to approximately 25% of full capacity, the microcontroller 50 reduces the water surface cleaning machine's power consumption further by powering the DC motors 30, 31 intermittently. For example the water surface cleaning machine will travel normally for two minutes and then remain motionless for two minutes. Zero voltage is applied to the DC motors 30, 31 during the two minutes the water surface cleaning machine remains motionless. This on-off time ratio will decrease continuously, if the batteries' 70 charge drops further. If the batteries' 70 charge drops to 10% of full capacity, the microcontroller 50 puts the water surface cleaning machine into a standby mode. In this mode, zero power is supplied to the DC motors 30, 31 to conserve the batteries' 70 remaining energy, since at this charge level there is only stored charge sufficient for minimal water surface cleaning machine travel time. The water surface cleaning machine remains in this mode until the rechargeable batteries 70 have been sufficiently recharged by the solar cell 75 or until the water surface cleaning machine is commanded by the remote transmitter 105 to a different location. The microcontroller 50 puts the water surface cleaning machine into the standby mode, while there is enough charge left in the rechargeable batteries 70 that the radio control transmitter 105 can command the water surface cleaning machine to travel to a desired location. This prevents the water surface cleaning machine from being stranded in the middle of a pool or lake.

Several rechargeable battery 70 technologies are useful for this application. Nickel Cadmium (NiCad) is one of the more mature technologies, offering standard battery sizes with large energy capacities. However NiCad technology suffers from the memory effect. Unless NiCad batteries are fully charged and then fully discharged before being recharged, their energy storage capacity will decrease. To minimize problems caused by the memory effect, two sets of NiCad batteries could be used to power the water surface cleaning machine. One set could power the boat until full battery discharge is reached, while the other battery is charged to full capacity. NiCad batteries are available from a number of manufacturers including Power Stream Technology, Orem, Utah.

NiMH is a newer rechargeable battery 70 technology. It is available in standard sizes like the NiCad batteries, but stores 40% more energy in the same size package. In addition a NiMH battery doesn't suffer from the memory effect. These batteries can be charged and discharged at anytime, with minimal degradation to the battery. This characteristic is ideal for this water surface cleaning machine. If a relatively large capacity NiMH battery 70 is chosen, it could provide power over considerable time, and can be partially recharged whenever power is available. NiMH batteries are available from a number of manufacturers including Power Stream Technology, Orem, Utah

The microcontroller 50 controls the charging and discharging of the batteries 70 with a goal of maximizing the water surface cleaning machine's performance, while maintaining the functionality of the batteries 70. In the preferred embodiment NiMH rechargeable batteries 70 power the DC motors 30, 31. Since NiMH batteries 70 don't suffer from the “memory effect”, they are fully charged whenever power from the solar cell 75 is available. The microcontroller 50 monitors the NiMH batteries' 70 temperature and voltage to prevent overcharging that can lead to battery degradation or destruction.

The temperature of a NiMH battery increases significantly as the NiMH battery becomes overcharged. For example the temperature of a NiMH battery going from fully charged to overcharged can rise from 25° C. to between 35° C. and 45° C., depending on the recharging rate. A temperature sensing circuit 240 is used to monitor the batteries' 70 temperature. This temperature sensing circuit 240 contains a thermistor 6 that is placed in thermal contact with the batteries 70. This is accomplished by placing the thermistor in physical contact with the batteries 70 or in physical contact with a high thermal conductivity material that is in physical contact with the battery. A thermistor 6 is a resistor whose resistance varies with temperature. The thermistor 6 is included in a voltage divider to form a temperature sensing circuit 240, whose output voltage is a function of the temperature of the thermistor. This output voltage is inputted into the analog to digital converter and monitored by the microcontroller 50. The microcontroller 50 determines when the NiMH batteries 70 go from full charge to overcharge by monitoring the temperature of the NiMH batteries 70. Other temperature sensitive devices can be used to measure the batteries' 70 charge including thermocouples and diodes.

The NiMH batteries' 70 voltage level can also be used to determine when said batteries 70 go from full charge to overcharge. A single NiMH battery's voltage will increase to approximately 1.4 Volt at full charge from 1.2 Volt at lower charge levels. As a NiMH battery's charge goes from full charge to overcharge, its voltage decreases slightly. The microcontroller 50 can determine when the NiMH batteries 70 reaches full charge by determining when their voltage peaks. This method however is typically not as reliable as the temperature method, since the differential voltage levels can be small. A second disadvantage to this voltage method, is that the batteries 70 actually need to be overcharged to exhibit the slight decrease in battery voltage. This is the condition that one is trying to avoid, since it can cause battery degradation. In this embodiment, the temperature method is used as the primary method to determine full charge and the battery voltage method is used as a backup to increase system reliability.

Batteries' 200, 70 voltages can be measured by connecting the batteries 200, 70 to voltage dividers whose outputs are inputted into the analog to digital converter located in the PIC16C72 50. The voltage dividers reduce the battery voltage to a level that can be sampled by the analog to digital converter. This embodiment contains two of these dividers 260, 270, one for measuring the 9 Volt battery's 200 voltage, and one for measuring the rechargeable batteries' 70 voltage. The voltage dividers 260, 270 each contain two resistors. In this embodiment 1,000,000 ohm and 100,000 ohm resistors were chosen. Values greater than 100,000 ohm were chosen to minimize current draw from the batteries 200, 70 and to prevent loading the analog to digital converter contained in the microcontroller 50. These dividers 260, 270 draw approximately 9 micro amps from the 9 Volt battery 200 and less for the rechargeable batteries 70. These voltage dividers 260, 270 output approximately 10% of the battery voltage. Therefore a fully charged 9 Volt battery 200, will be output approximately 0.90 Volts into the analog to digital converter. This voltage level is easily sampled by the analog to digital converter. Typically analog to digital converters sample voltages on the order of several volts.

The solar cell's 75 output is monitored to minimize the probability of overcharging the rechargeable batteries 70. As the rechargeable batteries 70 approach full charge, the microcontroller 50 modulates the current charging the batteries 70 to decrease the batteries' 70 charging rate. This is done by modulating a switch 280 that is in series with the solar cells 75. This reduces the average current flowing from the solar cells 75 and into the rechargeable batteries' 70. When the batteries' 70 reach full charge, the microcontroller modulates the SPST switch 280 to allow only a small trickle charge to the batteries. This prevents the batteries 70 from overcharging, but maintains full battery 70 charge. The solar cell's 75 output is monitored using a solar cell output sensing circuit 285. This circuit contains a small resistance in series with the output line from the solar cell 75. This resistor is typically 0.1 ohm or less to minimize the dissipated power in said resistor. The ST10 10 watt solar cell 75 from Shell Solar is being used in this embodiment. This solar cell 75 can output almost 1 amp under full sunlight. Therefore maximum power dissipation in the 0.1 ohm resistor is approximately 0.1 W or 1% of the maximum power output of the ST10 solar cell. A low power operational amplifier 82 may be included in the solar cell output sensing circuit 285 to amplify the signal across said resistor to a value that can be measured accurately by the microcontroller's 50 analog to digital converter. The LM324 operational amplifier by National Semiconductor can be used for this application. The sensing circuit 285 may also include a series diode 68 to prevent current from flowing from the batteries 70 to the solar cells 75. Commercial integrated circuits such as the MAX719 from Maxim Integrated Products can also be used to recharge the batteries 70 using solar cells.

The water surface cleaning machine containing both manual and automatic modes includes a control panel located on the exterior of the housing 1. The control pad contains an on/off switch 310 and a toggle switch 321 that toggles the water surface cleaning machine between an automatic mode and a manual mode. The control panel includes a liquid crystal display 330 (LCD) to show the current state of charge of the batteries 70, the electrical current output from the solar panel 75 and the water surface cleaning machine's mode of operation. Since the LCD 330 consumes very little power, it is driven directly by the microcontroller 50 thereby eliminating extra parts and conserving energy.

The following is a list of the key hardware components, and their sources, described in the above embodiment: one radio control 3PK TI Black 75 three channel transmitter 105, Futaba, Champaign, Ill. (includes antenna 106); one radio control R113iP 3 channel receiver (including 75 MHz crystal) 100, Futaba, Champaign, Ill.; one BRUM5110 radio control antenna 101, Bru-Line Industries, Center Line, Mich.; two 208D 6 Volt Electronic Speed Controls 50a, 50b, Astro-Flight, Marina Del Ray, Calif.; five D 2100 mah NiMH rechargeable batteries 70, Power Stream Technology, Orem, Utah; one PIC16C72 microcontroller 50, Microchip Technology Inc., Chandler, Ariz.; one 155421 RFO type flow sensor 110, Gems Sensors, Plainville, Conn.; two TL1100C pressure sensor/momentary switches 131, 132, E-Switch, Brooklyn Park, N.Y.; one SN754410 Dual DC motor H Bridge 60, Texas Instruments, Dallas, Tex.; one ST10 Photovoltaic Solar Module 75, Shell Solar, Camarillo, Calif.; one LM324 operational amp 82, National Semiconductor, Santa Clara, Calif.; one TK11445 voltage regulator 295, Toko, Mt. Prospect, Ill.; one VI-302-DP-RC-S LCD 330, Varitronix LTD., Hong Kong; one EFO-EC4004A4 4 MHz resonator 52, Matshushita Electric Corporation of America (Panasonic), Secaucus, N.J.; one surface mount NTC 100 K ohm thermistor 2322 615 33104 6, Vishay Inertechnology Inc., Malvern, Pa.; various discrete components including: 1 M ohm resistors, 1 K ohm resistors, a 0.1 ohm resistor, 0.1 uF capacitors, and a nine volt battery 200; one custom made housing 1 including debris basket 7.

Detailed Description of the Software to Control the Water Surface Cleaning Machine in the Automatic and Manual Modes

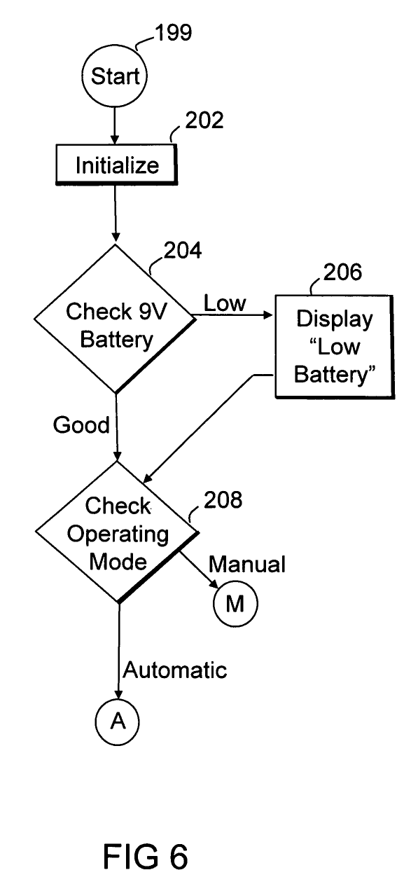

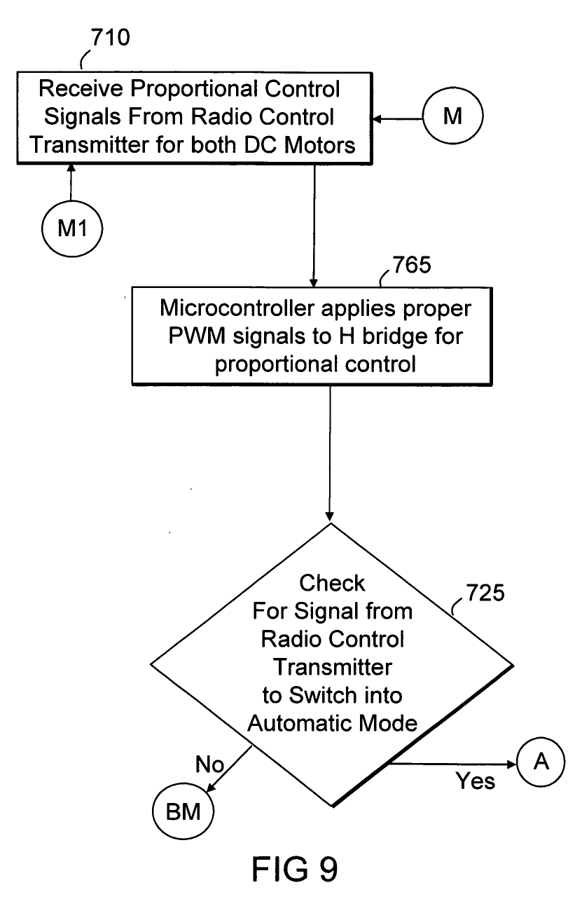

Flowcharts of the software to control the water surface cleaning machine in the automatic and manual modes are shown in FIG. 6, 7, 8, 9, 10. The main software routine is shown in FIG. 6 in flowchart form. The main software routine is responsible for checking the 9 Volt battery 200, and determining the user selected operating mode. Upon powering the machine 199, the microcontroller initializes 202, and measures 204 the voltage on the 9 Volt battery 200 powering the microcontroller 50. If the corresponding voltage is below 6 Volt, the microcontroller 50 displays “LOW BATTERY” 206 on the LCD 330. After checking the battery 200, the software polls 208 the voltage divider 320 containing the mode select switch 321 to determine the water surface cleaning machine's operating mode. If the water surface cleaning machine is in the manual mode, the software jumps to the manual subroutine shown in FIG. 9.

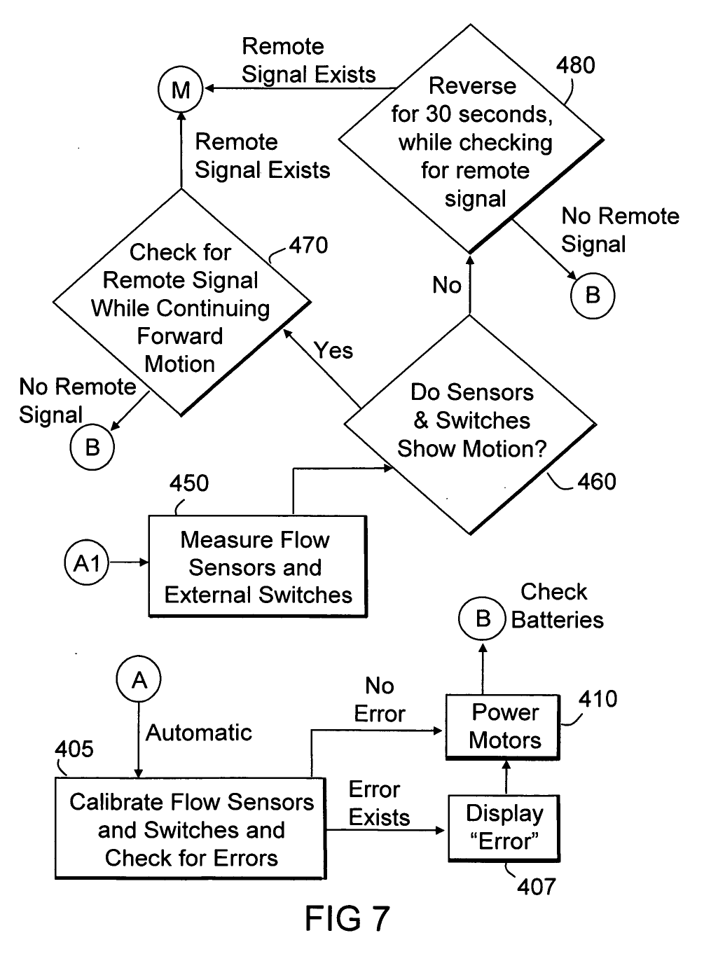

If the water surface cleaning machine is in the automatic mode, the software jumps to the automatic subroutine shown in FIG. 7. The automatic subroutine calibrates 405 the flow sensor 110 and switches 131, 132 and determines whether any errors exist. With zero power applied to the DC motors 30, 31, the microcontroller 50 measures 405 the voltage outputted by the voltage divider 130 containing the external pressure sensitive switches 131, 132 and the voltage outputted by the flow sensor 110. These values should be approximately equal to preprogrammed values, if not an error message 407 is displayed on the LCD 330. Whether or not an error existed, the software then applies a pulse width modulated signal to the H bridge 60, which then applies power 410 to the DC motors 30, 31. The water surface cleaning machine will then start moving across the pool of water, unless the water surface cleaning machine is being obstructed by an external object.

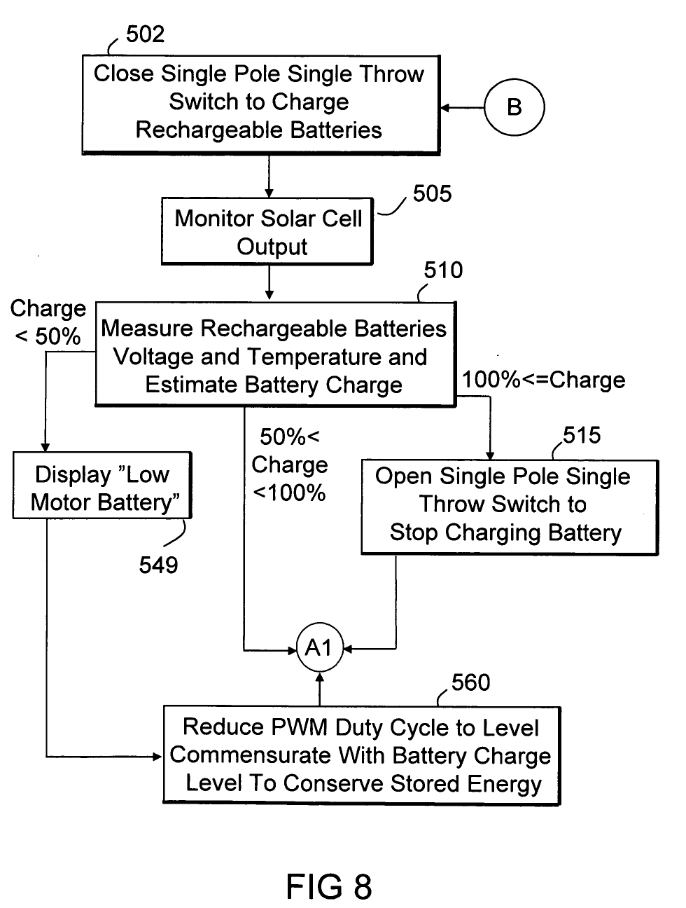

The automatic subroutine then measures the output of the solar cells 75 and the stored charge in the rechargeable batteries 70 shown in FIG. 8. The software closes 502 the single pole single throw switch 280 allowing the solar cell 75 to charge the rechargeable batteries 70. The output of the solar cell 75 is measured 505 to determine the amount of charge flowing into the rechargeable batteries 70. The stored charge in these batteries 70 is then estimated 510. If the charge is greater than 100% of the batteries' capacity, the software opens 515 the single pole single throw 280 switch to prevent further charging of the rechargeable batteries 70. The software then measures 450 the flow sensors 110 and external switches 131, 132. If the rechargeable batteries' 70 charge was greater than 50% of capacity and less than 100% the software allows the solar cells 75 to charge the rechargeable batteries 70 and jumps directly to the command 450 to measure the flow sensor 110 and external switches 131, 132. If the charge was less than 50% of the total rechargeable batteries' 70 capacity, “Low Motor Battery” is displayed 549 on the LCD 330. Since there aren't sufficient characters in the LCD to display “Low Battery” and “Low Motor Battery”, abbreviations are used. The software then reduces the Pulse Width Modulated duty cycle 560 to conserve the rechargeable batteries' 70 energy. The software then measures 450 the flow sensors 110 and external switches 131, 132.

If the water surface cleaning machine showed motion 460 and none of the pressure sensors 131, 132 were pressed, the software checks for a remote transmitted signal 470. If there is a remote signal the software jumps to the manual subroutine 710. If there wasn't a signal, the software jumps back to the battery test portion of the automatic subroutine 502. If the flow sensors 110 and pressure sensors 131, 132 show that the water surface cleaning machine has zero motion 460 or is in contact with an obstruction, then the water surface cleaning machine will attempt to reverse its direction of travel for 30 seconds 480, to pull itself away from the object that is preventing the water surface water surface cleaning machine's motion. While reversing its direction, the water surface cleaning machine is continually checking for a remote signal that is signaling it to go into the manual mode. If the water surface cleaning machine receives such a signal, then the software jumps to the manual subroutine 710. After 30 seconds of reverse motion while not receiving a remote signal, the software returns to the battery test portion of the automatic subroutine 502.

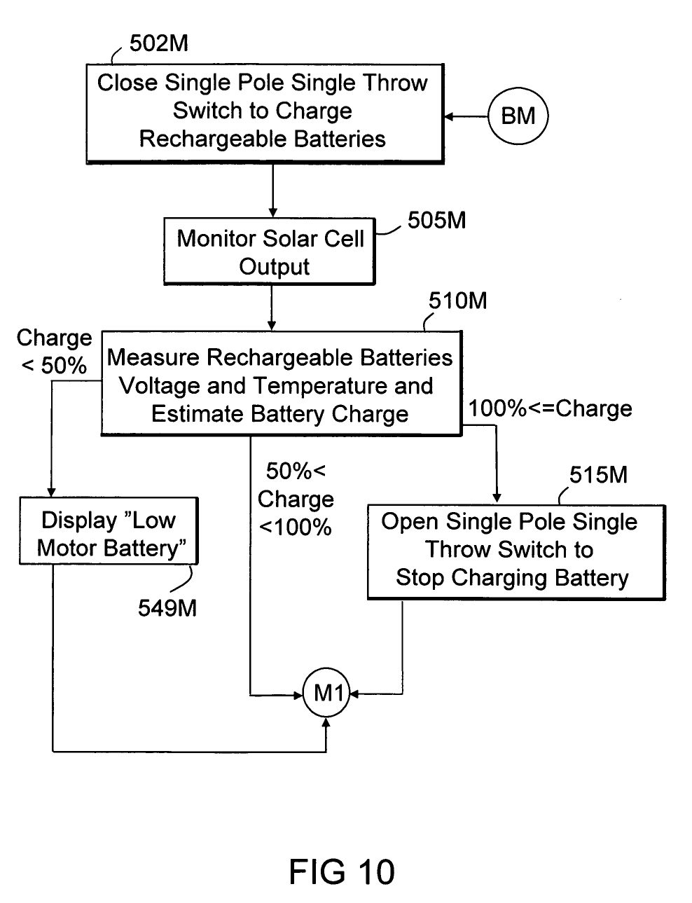

If the water surface cleaning machine was instructed to go into the manual mode, the software jumps to the manual subroutine 710 shown in FIG. 9 where the water surface cleaning machine receives proportional control signals from the remote transmitter 105. The microcontroller 50 applies 765 the proper pulse width modulated signals to the H bridge 60 for proportional control of the DC motors 30, 31. The software then checks 725 to see if a signal instructing the water surface cleaning machine to switch into the automatic mode was being transmitted. If this signal is received, the water surface cleaning machine jumps to the automatic software instruction set 405. If the automatic signal was not received, the software jumps to the battery test portion of the manual subroutine 502M where the output of the solar cells 75 and the stored charge in the rechargeable batteries 70 are measured shown in FIG. 10. The software closes 502M the single pole single throw switch 280 allowing the solar cell 75 to charge the rechargeable batteries 70. The output of the solar cell 75 is measured 505M to determine the amount of charge flowing into the rechargeable batteries 70. The stored charge in these batteries 70 is then estimated 510M. If the charge is greater than 100% of the batteries' capacity, the software opens 515M the single pole single throw 280 switch to prevent further charging of the rechargeable batteries 70. The software then jumps out of the battery test portion of the manual subroutine to receive 710 more proportional control signals from the remote transmitter. If the rechargeable batteries' 70 charge was greater than 50% of capacity and less than 100% the software allows the solar cells 75 to charge the rechargeable batteries 70 and jumps to the command 710 to receive additional proportional control signals. If the charge was less than 50% of the total rechargeable batteries' 70 capacity, “Low Motor Battery” is displayed 549 on the LCD 330. The software then jumps to the command 710 to receive additional proportional control signals.

What is claimed is:

1. A machine for cleaning a surface of a pool of water comprising:
a housing that floats on or near said surface of water; and
a means to collect debris from said surface of water; and
a propulsion system for propelling and steering said machine; and
a battery for powering said water surface cleaning machine; and
a receive antenna whereby electromagnetic control signals such as direction and speed can be collected; and
a receiver whereby said control signals can be received from said receive antenna; and
a transmitter and transmit antenna whereby a remote user can transmit said control signals to steer said machine towards floating debris for rapid cleaning of said surface of water.

2. The machine according to claim 1, wherein said means to collect debris from said surface of water includes a net or water permeable basket.

3. The machine according to claim 1, wherein said means to collect debris from said surface of water includes a weir whereby collected debris remains substantially within said collection means.

4. The machine according to claim 1, further including a means to monitor the stored charge of said battery.

5. The machine according to claim 1, further including a solar cell whereby said solar cell can recharge said battery or power said water surface cleaning machine.

6. The machine according to claim 1, wherein said propulsion system includes one or more DC motors for propelling said machine.

7. The machine according to claim 6, further including speed control for controlling the speed of said DC motor.

8. The machine according to claim 7, wherein said speed control uses H bridges to supply current to said DC motors.

9. The machine according to claim 1, wherein said machine's movements are controlled by controlling the thrust of one paddle wheel or propeller relative to a second paddle wheel or propeller.

10. A machine for cleaning a surface of a pool of water comprising:
a housing that floats on or near said surface of water; and
a propulsion system for propelling and steering said machine; and
a means to collect debris from said surface of water; and
a controller for controlling the operation of said machine; and
an automatic mode, whereby said machine operates substantially autonomously collecting debris from said surface of water.

11. The machine according to claim 10, further including an analog to digital converter for converting analog inputs into digital data, whereby analog data from sensors and switches can be inputted into said controller.

12. The machine according to claim 10, wherein said propulsion system includes one or more DC motors for propelling said machine.

13. The machine according to claim 10, further including speed control for controlling the speed of said DC motor.

14. The machine according to claim 10, wherein said machine's movement is controlled by controlling the thrust of one paddle wheel or propeller relative to a second paddle wheel or propeller.

15. The machine according to claim 10, further including a rechargeable battery for powering said water surface cleaning machine.

16. The machine according to claim 10, further including a means to monitor the stored charge of said rechargeable battery.

17. The machine according to claim 16, wherein said means to monitor the stored charge of said rechargeable battery includes a means to measure the temperature of said rechargeable battery.

18. The machine according to claim 10, further including a solar cell as a power source whereby said solar cell can recharge said battery or power said water surface cleaning machine.

19. The machine according to claim 10, further including separate batteries to power said DC motor and said controller.

20. The machine according to claim 10, wherein said automatic mode manages said machine's resources whereby said machine's performance is maximized, while maintaining the functionality of said battery.

21. The machine according to claim 10, further including an energy conservation mode, whereby said propulsion system can be put into a low power consumption mode to preserve said machine's stored energy.

22. The energy conservation mode according to claim 21, wherein said energy conservation mode includes controlling the duty cycle or on time of the pulse width modulator to reduce said rechargeable battery's energy drain.

23. The energy conservation mode according to claim 21, further including turning off the DC motors for extended periods of time.

24. The machine according to claim 10, further including a motion sensor whereby motion of said machine can be monitored.

25. The machine according to claim 10, further including switches or pressure sensors located on the exterior of said machine's housing whereby contact between said machine and a wall or other obstacle can be detected

26. The machine according to claim 25, wherein said automatic mode monitors the state of switches or pressure sensors located on the exterior of said machine's housing whereby contact between said machine and a wall or other obstacle can be detected

27. The machine according to claim 10, wherein said automatic mode includes programmed routines for traveling around a pool of water whereby said machine can more efficiently clean said surface of water.

28. The machine according to claim 10, further including a receive antenna whereby electromagnetic control signals including direction and speed can be collected.

29. The machine according to claim 28, further including a receiver whereby said control signals can be received from said receive antenna.

30. The machine according to claim 10, further including a manual operating mode, whereby said machine can be manually steered to desired location.
